(19) United States
(12) Patent Application Publication
(10) Pub. No.: US 2025/0364579 A1
(43) Pub. Date: Nov. 27, 2025

(54) MEMBRANE STACK ASSEMBLY FOR A HUMIDIFIER OF A FUEL CELL SYSTEM

(71) Applicant: MAHLE International GmbH, Stuttgart (DE)

(72) Inventors: Ruediger Knauss, Kernen i.R. (DE); Stefan Kaiser, Remseck (DE); Niko Storz, Reichenbach (DE); Ingo Haeusler, Esslingen (DE); Till Becker, Wimsheim (DE)

(21) Appl. No.: 19/213,967

(22) Filed: May 20, 2025

(30) Foreign Application Priority Data
May 21, 2024 (DE) 102024114189.1

(51) Int. Cl. H01M 8/04119

(52) U.S. Cl. CPC H01M 8/04149

(57) ABSTRACT

A membrane stack assembly for a humidifier in a fuel cell system is disclosed. The assembly includes a membrane stack having first and second fluid paths, allowing separate flow of two fluids while enabling moisture transfer through gas-tight, moisture-permeable membranes. The membranes are arranged in a spaced, stacked configuration along a stacking direction between two opposing end plates. At least one belt is provided, with a first belt section positioned on an outer side of the first end plate and a second belt section positioned on an outer side of the second end plate, securing the membrane stack between the end plates.

### CROSS-REFERENCE TO RELATED APPLICATION

This application claims priority to German Patent Application No. 102024114189.1, filed on May 21, 2024, the contents of which is hereby incorporated by reference in its entirety.

### TECHNICAL FIELD

The invention relates to a membrane stack assembly for a humidifier in a fuel cell system, and to a humidifier with such a membrane stack assembly.

### BACKGROUND

Conventional membrane stacks for humidifiers comprise membranes stacked on top of each other, each with a membrane layer that is impermeable to gas and permeable to moisture or water or water vapor. A space is formed between the individual membrane layers or membranes through which the gas can flow, thus forming a gas path. This means that a gas to be humidified can flow over one side of the membrane stack in the humidifier and a humid gas can flow over the other side. The two gases are separated from each other by the membrane layer of the respective membrane. Consequently, there is no mixing of the two gases flowing through the humidifier and the membrane stack. However, the moisture from the damper gas can pass through the membrane layer and be absorbed by the drier gas to moisten it. The moisture of the two gases thus equalizes when flowing through the membrane stack.

### SUMMARY

Such humidifiers are often used in fuel cell systems where dry cathode supply air has to be humidified before it is fed to the fuel cell. The cathode supply air must be humidified to prevent or at least delay the drying out of the polymer electrolyte membranes typically used in a fuel cell. Such drying out, which can be avoided by using a humidifier, has a particularly negative effect on the durability of polymer electrolyte membranes and the efficiency of the fuel cell.

However, when the membrane stack is used in a humidifier, the pressurized air flowing through the gas paths can cause the membrane stack to bulge in an undesirable way, especially in a stacking direction in which the individual membranes of the membrane stack are stacked on top of each other. This can cause damage and, in extreme cases, even destroy the membranes of the membrane stack.

It is therefore an object of the present invention to provide an improved membrane stack assembly comprising a membrane stack in which the aforementioned disadvantage is eliminated or at least counteracted. In particular, the aim is to create a solution that is as cost-effective as possible. This problem is solved by the subject matter of the independent claims. Preferred embodiments are the scope of the dependent claims.

The basic idea of the invention is therefore to brace a membrane stack, which is bounded in the stacking direction by two mechanically rigid end plates—such a membrane stack with end plates is hereinafter referred to as a “membrane stack assembly”—by means of a belt that is routed around the outside of the membrane stack, including the two end plates, and rests at least on the outside of the two end plates. This can at least counteract any unwanted expansion of the membrane stack and its end plates. In practice, this scenario occurs at the latest when pressurized air flows through the membrane stack assembly in a humidifier during operation and the membrane stack wants to expand in the stacking direction as a result. The belt is therefore preferably arranged on the membrane stack or the end plates in such a way that it completely prevents pressure-induced expansion of the membrane stack. In this way, the above-mentioned damage or destruction of the membranes due to said bulging can be prevented with comparatively little technical effort and thus also at low cost.

In detail, a membrane stack assembly according to the invention comprises a membrane stack having first fluid paths through which a first gas can flow and having second fluid paths through which a second gas can flow. The first and second fluid paths are separated from each other by means of membranes that are stacked on top of each other in a stacking direction, with each membrane being gas-tight and permeable to moisture.

This means that a gas to be humidified can flow over one side of the membrane and a humid gas can flow over the other side. The two gases are separated from each other by the membrane. Consequently, the two gases flowing over the membrane do not mix. However, the moisture from the damper gas can pass through the membrane and be absorbed by the drier gas to moisten it. The humidity of the two gases thus equalizes.

A spacer structure can be arranged between adjacent membranes in the stacking direction, i.e., in a respective fluid path formed by a space between these membranes, on which two adjacent membranes in the stacking direction are supported.

Furthermore, the membrane stack assembly includes a first and a second end plate, which are located opposite each other along the stacking direction and between which the membrane stack with the individual membranes is arranged. The two end plates limit the membrane stack assembly along the stacking direction. Plastic or metal, especially aluminum, can be chosen as the material for the end plates. At least one end plate can have a ribbed structure for mechanical stiffening. Furthermore, the membrane stack assembly comprises at least one belt, which rests with a first belt section on an outer side of the first end plate facing away from the membrane stack and rests with a second belt section on an outer side of the second end plate facing away from the membrane stack.

In a preferred embodiment, at least one belt can be designed and/or act as a tensioning belt, thereby exerting a prestressing force on at least one end plate and preferably on at least both end plates. By means of the belt formed as a tensioning belt, a force can already be exerted on the two end plates, which prevents or at least limits an expansion of the membrane stack, without an expansion of the membrane stack having to have already taken place-starting from a nominal state with a nominal expansion of the membrane stack in the stacking direction associated with this nominal state. This is particularly effective in counteracting unwanted expansion of the membrane stack along the stacking direction.

Preferably, at least one belt runs completely around the two end plates and the membrane stack in a closed loop. The belt is therefore completely wrapped around the membrane stack. In this way, the belt can be firmly attached to the membrane stack and, in the event of bulging, can immediately take effect as a tensioning belt to counteract the bulging.

According to a favorable further development, the membrane stack and the two end plates exhibit the geometry of a cuboid with six outer sides. The first outer side is formed by the first end plate and a second outer side by the second end plate. The belt or tensioning belt resting on the end plates thus prevents expansion along the stacking direction, which extends perpendicular to the first and second end plates. In this further development, the belt with a third belt section connecting the first belt section to the second belt section extends along a third outer side of the cuboid, which is different from the first and second outer sides and connects these two outer sides. Alternatively, the belt may extend along an edge between two outer sides of the cuboid that are different from the first and second outer sides. In both variants of this further development, the belt can be mounted particularly easily.

The belt can extend in a particularly preferred manner with a third belt section connecting the first belt section to the second belt section over a third outer side of the cuboid, which is formed by the membrane stack and connects the first outer side to the second outer side. Furthermore, the belt extends with a fourth belt section connecting the first belt section to the second belt section over a fourth outer side of the cuboid, which is formed by the membrane stack and lies opposite the third outer side, connecting the first outer side to the second outer side. When the belt or tensioning belt is arranged in this way on the cuboid, the belt pressing on the two end plates can be used to generate a uniform counter-pressure when the membrane stack expands along the stacking direction, which uniformly counteracts the expansion of the membrane stack in the stacking direction.

Preferably, the first and second outer sides of the cuboid each have the geometry of a rectangle. In this variant, the first and second belt sections each extend along a center longitudinal axis of the rectangle. By arranging the belt or the tensioning belt along the center longitudinal axis, a particularly even contact pressure is achieved on the two end plates, and unwanted lateral “slipping” of the belt from the two end plates is made more difficult.

According to another advantageous further development, two belts can also be provided which extend orthogonally to each other on the cuboid. This helps to even out the back pressure. In addition, a redundant structure is created in which, if one of the two belts fails, the other belt can still achieve the effect according to the invention.

The cuboid is particularly preferred to have a third, fourth, fifth, and sixth outer side, all of which connect the first outer side to the second outer side of the cuboid. In this variant, a third belt section of the belt connecting the first belt section and second belt section extends along a first edge formed between the third and fifth outer sides and also rests against this edge. Similarly, a fourth belt section of the belt connecting the first belt section and second belt section extends along a second edge formed between the fourth and sixth outer sides and also rests against this edge. This way, the sensitive sides of the membrane stack are protected from damage by the tensioning belt.

In another preferred embodiment, the first and second outer sides of the cuboid each have the geometry of a rectangle. In this embodiment, the first and second belt sections each extend along one of the two diagonals of the respective rectangle. This variant allows and supports the creation of a particularly even counterpressure by the two end plates in the event of expansion of the membrane stack in the stacking direction.

According to another advantageous further development, at least one belt is formed of at least two layers, preferably several layers, and has at least two or several belt layers arranged on top of one another. This can increase the mechanical strength of the belt. In particular, the back pressure generated by the belt when the membrane stack expands can be increased.

At least two layers, but preferably all layers, of at least one belt may be joined together in a materially integral manner along their entire length by means of a welded joint. This prevents individual belt layers from coming loose from the remaining belt layers. Furthermore, the mechanical strength of the belt is increased again compared to designs in which two or more belt layers are present, but these only lie loosely on top of each other or against each other, i.e., without a welded connection.

In an alternative preferred embodiment, at least two layers, preferably all layers, of at least one belt, in particular only, can be joined to one another in sections in a materially integral manner by means of a welded connection. This variant is easier to manufacture and assemble than the previously explained design with belt layers welded together and is therefore particularly cost-effective.

The welded connection in particular may be formed exclusively in the first and second belt sections of the belt. A particularly good compromise between the two previous designs in terms of manufacturing costs and the mechanical strength achieved is obtained when the welded connection explained above is provided between at least two belt layers in the first and second belt sections of the belt, but not in the third and fourth belt sections. This means that the welding of the belt layers only occurs on the insensitive outer sides of the end plates, but any damage to the edge region of the sensitive membranes of the membrane stack due to the effect of heat, caused by the welding process, is avoided.

According to another preferred embodiment, a guide can be formed on the first or/and second end plate, in which the first or second belt section of the belt is arranged. This guide simplifies the installation of the belt in the region of the two end plates and also ensures that the belt is securely fixed after installation.

According to a further advantageous development, a radius can be formed in the end plate on at least one transition of the first and/or second end plate to the membrane stack, on which the belt rests. In this way, damage to the belt at the edge formed between the respective end plate and the membrane stack is at least counteracted.

The belt is particularly preferably extended in a longitudinal direction and comprises a belt material which has fibers, in particular glass fibers, that are extended in the longitudinal direction, which in turn are embedded in a plastic matrix, preferably of a thermoplastic. This means that the plastic of the plastic matrix surrounds the fibers. A belt produced in this way has high strength, particularly in the longitudinal direction, and is also available at a commercially favorable cost.

Preferably, the longitudinal tensile strength of the belt measured in the longitudinal direction is at least five times, preferably ten times, the transverse tensile strength measured perpendicular to the longitudinal direction. In this way, the belt or tensioning belt, which is primarily stressed along the length of the membrane stack in the event of the stack bulging, is provided with the ability to exert a pre-tensioning force on the end plates in order to counteract said bulging.

The belt material is particularly functional when at least 70% by weight is formed by the fibers or glass fibers. This way, the belt can achieve an especially high tensile strength, particularly in the longitudinal direction and in relation to a direction perpendicular to the longitudinal direction.

According to a favorable modification of the membrane stack assembly according to the invention, at least one membrane, preferably each of the membranes of the membrane stack, comprises three membrane layers. Of these three membrane layers, a first membrane layer and a second membrane layer are each formed by a carrier layer. One of the three membrane layers is formed by a functional layer that is arranged between the two carrier layers. In this further development, the spacer structure is arranged on the outer side of the first carrier layer, facing away from the functional layer. The functional layer is designed to be gas-tight and moisture-permeable.

In a humidifier according to the invention, such a membrane of the membrane stack can be passed over on one side by dry air to be humidified and on the other side by moist air to humidify the air to be humidified. The air to be humidified is separated from the humid air by a membrane. Consequently, there can be no mixing of the humid air flowing through the membrane stack with the air to be humidified flowing through the membrane stack. However, the moisture from the damper gas can pass through the membrane layer and be absorbed by the drier gas to moisten it. The moisture of the two gases thus equalizes when flowing through the membrane stack.

According to an advantageous further development, a layer material of the functional layer can comprise or be, in particular expanded, polytetrafluoroethylene (ePTFE)—also known to the person skilled in the art as “Teflon.” This layer material is both impermeable to gas and permeable to moisture.

Alternatively or additionally, the carrier material of at least one carrier layer, preferably both carrier layers, may comprise or consist of polyethylene (PET) or polyphenylene sulfide (PPS). These materials give the membrane the necessary mechanical stability while taking up little space.

The invention further relates to a humidifier for a fuel cell system and for humidifying a first gas with moisture from a second gas. The humidifier comprises a housing that delimits a housing interior and a membrane stack assembly, which is arranged in the housing interior, has been previously presented and is thus in line with the invention. The advantages of the membrane stack assembly according to the invention, as explained above, are therefore transferred to the humidifier according to the invention. The humidifier comprises two gas inlets formed at a distance from each other on the housing for introducing the humid gas and the gas to be humidified into the housing interior and, furthermore, two gas outlets formed at a distance from each other on the housing for discharging the humid gas and the gas to be humidified from the housing interior.

Further important features and advantages of the invention are apparent from the dependent claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

The following is shown-schematically in each case—in the images below:

FIG. 1 shows an example of a membrane stack assembly according to the invention, shown in a perspective view;

FIG. 2 shows a part of the membrane stack assembly of FIG. 1 in a side view;

FIG. 3 shows a single membrane of the membrane stack assembly of FIGS. 1 and 2, roughly schematic and in a side view;

FIG. 4a shows the belt of the membrane stack assembly of FIGS. 1 through 3 in a separate illustration and in a plan view;

FIG. 4b shows the belt in FIG. 4 in a side view;

FIG. 5 shows an enlarged view of the membrane stack assembly of FIG. 1 in the region of the first end plate;

FIG. 6 shows an enlarged view of the membrane stack assembly of FIG. 1 in the region of a transition from the first end plate to the membrane stack;

FIG. 7 shows in a perspective view, a variant of the example of FIGS. 1 through 3, in which two belts are provided;

FIG. 8 shows the membrane stack assembly of FIG. 7 in a plan view of the first end plate; and

FIG. 9 shows an example of a humidifier according to the invention with a membrane stack assembly according to the invention in an exploded view.

### DETAILED DESCRIPTION

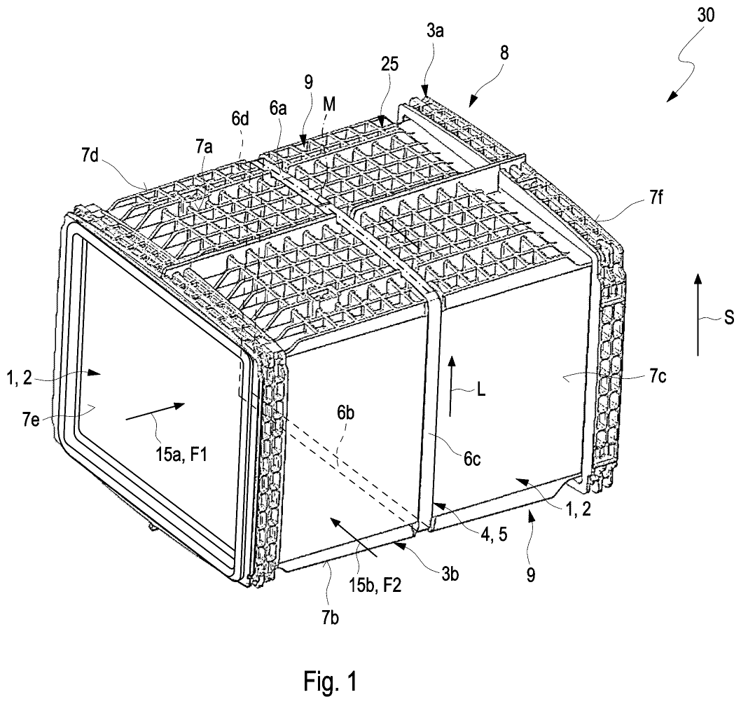

FIG. 1 illustrates an example of a membrane stack assembly 30 according to the invention in a perspective view. This comprises a membrane stack 1 with first fluid paths 15a through which a first fluid F1 or first gas can flow and with second fluid paths 15b through which a second fluid F2 or second gas can flow.

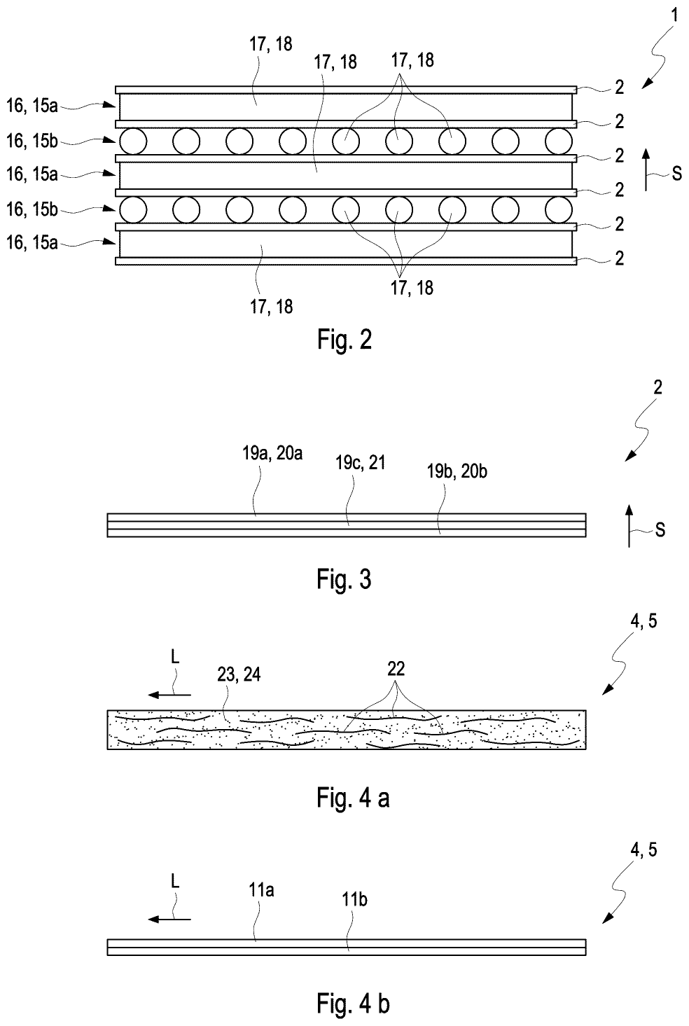

For clarification, FIG. 2 shows part of the membrane stack 1 of FIG. 1 in a roughly schematic representation and in a side view.

The first and second fluid paths 15a, 15b are thus separated from each other by means of stacked, mutually spaced, gas-tight, and moisture-permeable membranes 2 in a stacking direction S.

According to FIG. 2, the membrane stack 1 has a plurality of gas-tight and moisture-permeable membranes 2 stacked on top of each other in a stacking direction S. The membranes 2 are stacked on top of each other along the stacking direction S by means of a respective spacer structure 17, forming a respective intermediate space 16 through which a fluid or gas can flow. Along the stacking direction S, the individual spaces 16 each form a first or a second fluid path 15a or 15b. Each of the spacer structures 17 can have several spacer elements 18, which are arranged at a distance from one another in the respective intermediate space 16.

Thus, moist air flowing through a respective first fluid path 15a can flow over each of the membranes 2 of the membrane stack 1 on one side, and air to be humidified flowing through a second fluid path 15b can flow over them on the other side. The humid air and the air to be humidified are separated from each other by a respective gas-tight membrane 2. Consequently, there is no mixing of the moist air with the air to be humidified. However, the moisture contained in the more humid air can pass through the respective moisture-permeable membrane 2 and be absorbed by the drier air to moisten it.

FIG. 3 shows a single membrane 2 of the membrane stack 1 in a greatly simplified representation and in a side view. Accordingly, the gas-tight and moisture-permeable membrane 2 can have three membrane layers 19a, 19b, 19c arranged on top of each other (not visible in FIGS. 1 and 2). Of these three membrane layers 19a-19c, a first membrane layer 19a and a second membrane layer 19b are each formed by a carrier layer 20a, 20b. A third 19c of the three membrane layers 19a-19c is formed by a functional layer 21, which is sandwiched between the two carrier layers 20a, 20b along the stacking direction. The functional layer 21 comprises a gas-tight and moisture-permeable material. A layer material of the functional layer 21 with these properties is, for example, polytetrafluoroethylene (PTFE or ePTFE), in particular expanded polytetrafluoroethylene (PTFE or ePTFE). One of the two carrier layers, 20a, 20b, can be made of polyethylene, PET or polyphenylene sulfide (PPS), for example, which provides the necessary mechanical stability.

Referring again to FIG. 1, the membrane stack assembly 30 includes first and second end plates 3a, 3b that face each other along the stacking direction S. The membrane stack 1 with the membranes 2 is arranged between the two end plates 3a, 3b. The two end plates 3a, 3b thus delimit the membrane stack assembly 30 along the stacking direction S. One of the materials of the two end plates 3a, 3b can be a plastic, for example polypropylene (PP), polyamide (PA), polyphthalamide (PPA), or polyphenylene sulfide (PPS), in each case with glass fiber content, or a metal, for example aluminum. For mechanical stiffening, both end plates 3a, 3b can each have a ribbed structure 25 on the outside, i.e., facing away from the membrane stack 1.

In the example, the membrane stack 1 and the two end plates 3a, 3b together have the geometric shape of a cuboid 8 with six outer sides 7a-7f facing away from the membrane stack 1. In this case, a first outer side 7a of the cuboid 8 is formed by the first end plate 3a and a second outer side 6b of the cuboid 8 is formed by the second end plate 3b. The first and second outer sides 7a, 7b are thus opposite each other in the stacking direction S. A third, fourth, fifth, and sixth outer side 7c-7f of the cuboid 8 each connect the first outer side 7a with the second outer side 7b and are each formed by the membrane stack 1. The third outer side 7c is opposite the fourth outer side 7d, and the fifth outer side 7e is opposite the sixth outer side 7f.

According to FIG. 1, the membrane stack assembly includes a belt 4 that extends along a longitudinal direction L of the belt 4 over the first, second, third, and fourth outer sides 7a, 7b, 7c, 7d and is in contact with these four outer sides 7a-7d. The closed belt 4 running around the membrane stack 30 comprises four belt sections 6a-6d. The belt 4 rests with a first belt section 6a on the first outer side 7a and with a second belt section 6b on the second outer side 7b of the cuboid 8 and thus on the first and second end plates 3a, 3b. The first outer side 7a and the second outer side 7b each have the geometry of a rectangle 9 in a plan view along the stacking direction S. The first and second belt sections 6a, 6b extend in a plan view onto the first and second outer sides 7a, 7b along the stacking direction S, in each case along a center longitudinal axis M of the respective rectangle 9.

The belt 4 extends with a third belt section 6c, connecting the first belt section 6a with the second belt section 6b, along a third outer side 7c of the cuboid 8, which is different from the first and second outer sides 7a, 7b and connects these two outer sides 7a, 7b. In addition, the belt 4 extends along a fourth outer side 7d of the cuboid 8, which is different from the first and second outer sides 7a, 7b and connects these two outer sides 7a, 7b with a fourth belt section 6d connecting the first belt section 6a to the second belt section 6b. The third belt section 6c is therefore on the third outer side 7c, and the fourth belt section 6d is on the fourth outer side 7d. The fourth outer side 7d faces the third outer side 7c. Along the longitudinal direction L of the belt 4, the first, third, second, and fourth belt sections 6a, 6c, 6b, 6d follow one another. The belt 4 with the four belt sections 6a-6d runs closed and completely around the two end plates 3a, 3b and the membrane stack 1.

The belt 4 can be designed as a tensioning belt 5 and can also act as such and, in particular, exert a prestressing force on the end plates 3a, 3b in the event of an operational bulging of the membrane stack 1. Then, a prestressing force acting as a counterforce is exerted on the two end plates 3a, 3b by means of the tensioning belt 5, which prevents further expansion of the membrane stack in the stacking direction S.

FIG. 4a shows the belt 4 and the tensioning belt 5 of FIG. 1 in sections from above, FIG. 4b shows them in a side view. As roughly illustrated in FIGS. 4a and 4b, the belt 4 can comprise a belt material that has fibers 22, preferably glass fibers, in particular continuous glass fibers, extending along the longitudinal direction L. These fibers or glass fibers can be embedded in a plastic matrix 23 made of a thermoplastic 24, which means that the fibers 22 or glass fibers are surrounded by the thermoplastic 24. In the example, at least 70% by weight of the belt material is formed by the fibers or glass fibers. Due to the fibers or glass fibers extending in the longitudinal direction L, a longitudinal tensile strength of the belt 4 measured along the longitudinal direction L is at least five times, preferably ten times, a transverse tensile strength measured perpendicular to the longitudinal direction L.

The side view of FIG. 4b illustrates that the belts 4, 4a, 4b can each be formed in multiple layers. FIG. 4b shows an example of a single- or double-layer belt 4. This includes a first belt layer 11a and a second belt layer 11b arranged on the first belt layer 11a. In variants of the example, there may also be a different number of belt layers 11a, 11b arranged on top of each other. The two belt layers 11a, 11b of belt 4 are joined to each other along their entire length in a materially integral manner by means of a welded connection. Alternatively, however, it is also possible to join the individual belt layers 11a, 11b together in sections in a materially integral manner. In this case, it proves to be particularly advantageous to connect the two belt layers 11a, 11b to one another in a materially integral manner by means of a welded connection, at least in the first and second belt sections 6a, 6b of the belt 4, i.e., in the region of the two end plates 3a, 3b (see FIG. 1), and in particular to dispense with such a materially integral connection in the third and fourth belt sections 6c, 6d, so that the two belt layers 11a, 11b rest against each other without being firmly connected.

If a belt 4 with only a single belt layer 11a is used, this can be connected in the region of the overlapping end sections in a materially integral manner by means of a welded connection.

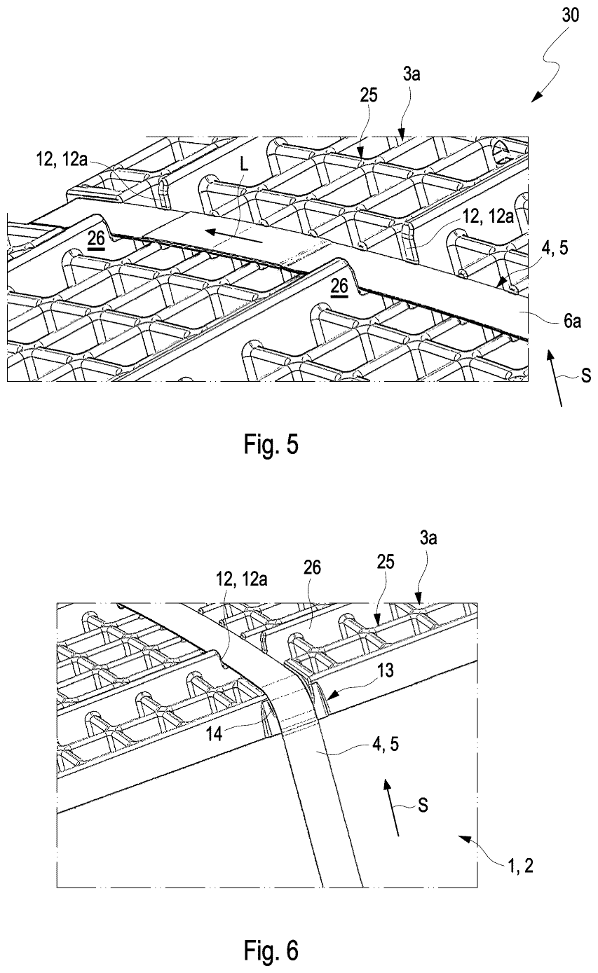

FIG. 5 is an enlarged view of the membrane stack assembly 30 in FIG. 1 in the region of the first end plate 3a. As shown in FIG. 5, a guide 12 can be formed on the first end plate 3a, in which the first belt section 6a of the belt 4 is arranged. If a rib structure 25 is formed in the end plate 3a as shown, the guide can be formed by recesses 12a formed in individual ribs 26 of the rib structure 25, through which the belt 4 or tensioning belt 5 engages as shown along the longitudinal direction L.

Such a guide can also be provided on the second end plate 3b (not shown in the figures).

FIG. 6 is an enlarged representation of the membrane stack assembly 30 of FIG. 1 in the region of a transition 13 from the first end plate 3a to the membrane stack 1. As clearly shown in FIG. 6, a radius 14 may be formed in the end plate 3a at the transition 13 of the first end plate 3a to the membrane stack 1, on which the belt 4 rests. A similar transition 13 can also be provided in the region of the second end plate 3b (not shown). Since both the first end plate 3a and the second end plate 3b—in a plan view along the stacking direction S—have two opposing transitions 13 to the membrane stack 1, two opposing radii 14 can also be provided on the first and second end plates 3a, 3b (not shown).

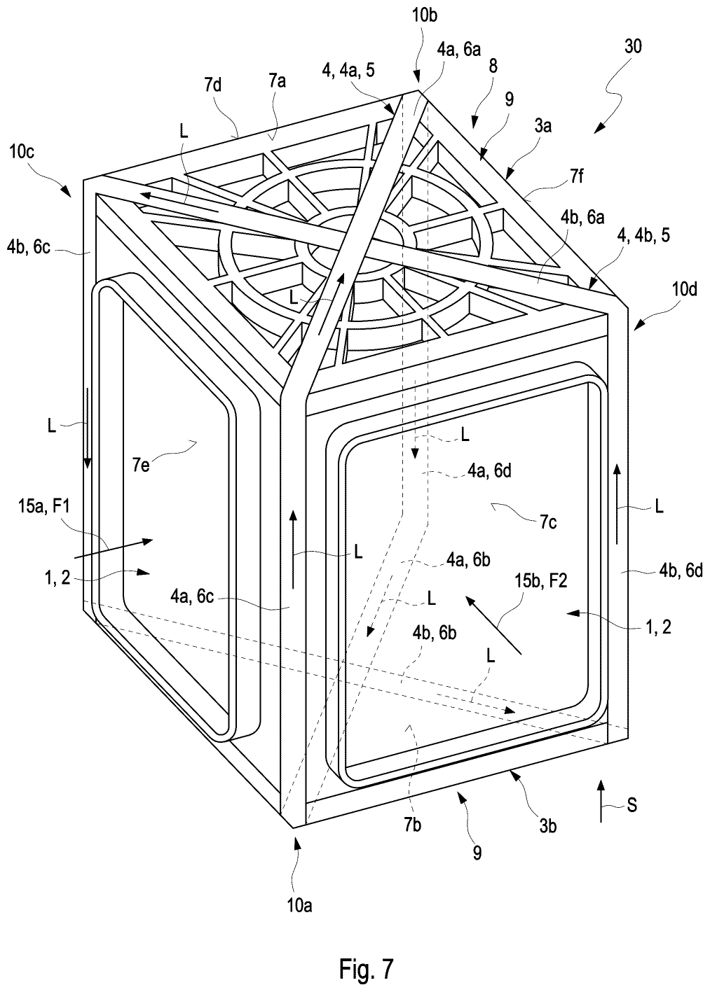

FIG. 7 shows a variant of the example of FIGS. 1 through 3, in which not only a single, but a first and a second belt 4a, 4b, i.e., two belts 4a, 4b are provided. Both belts 4a, 4b extend orthogonally to each other along a respective longitudinal direction L on the cuboid 8.

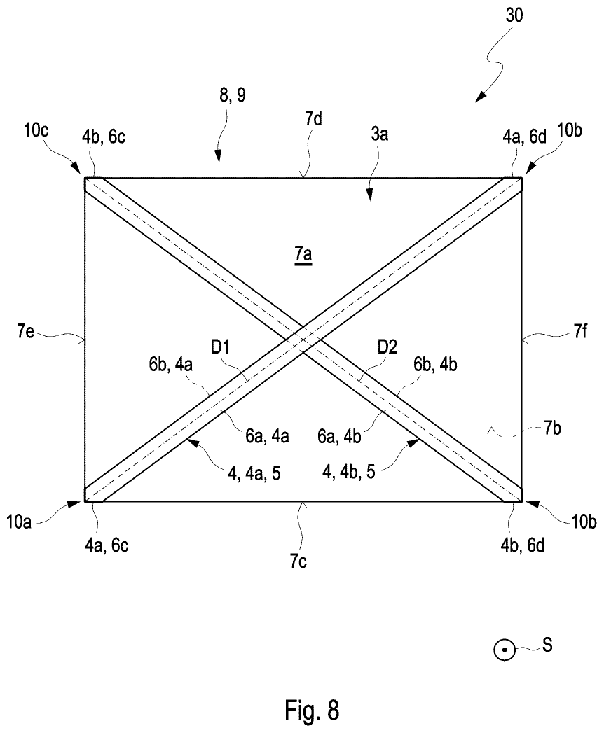

To illustrate this configuration, FIG. 8 shows the membrane stack assembly 30 of FIG. 7 in a plan view onto the first end plate 3a along the stacking direction S.

According to FIGS. 7 and 8, the first belt section 6a of the first belt 4a extends along the first D1 of the two diagonals D1, D2 of the rectangle 9 on the first outer side 7a. Accordingly, the first belt section 6a of the first belt 4a extends along a second D2 of the two diagonals D1, D2 of the rectangle 9 on the first outer side 7a. Similarly, the second belt section 6b of the first belt 4a extends along the first diagonal D1 of the two diagonals D1, D2 of the rectangle 9 on the second outer side 7b. Accordingly, the second belt section 6b of the second belt 4b extends along a second D2 of the two diagonals D1, D2 of the rectangle 9 on the second outer side 7b (not recognizable in the perspective of FIG. 7).

In both belts 4, 4a, 4b, the third belt section 6c does not extend, as in the example of FIGS. 1 through 3, on the third outer side 7c of the cuboid 8 and the fourth belt section 6d does not extend on the fourth outer side 7d. Rather, the third belt section 6c of the first belt 4a extends along a first ridge 10a formed between the third 7c and the fifth outer side 7e, and also rests against this first ridge 10a. Accordingly, in this variant, the fourth belt section 6d of the first belt 4a does not extend on the fourth outer side 7d of the quadrant 8, but along a second edge 10b formed between the fourth 7d and the sixth outer side 7f, and lies against this second edge 10b.

In a similar way, the third belt section 6c of the second belt 4b extends along a third edge 10c formed between the fourth 7d and the fifth outer side 7e, and lies against this third edge 10c. Accordingly, the fourth belt section 6d of the second belt 4b extends along a fourth ridge 10d formed between the third 7c and the sixth outer side 7f and rests against this fourth ridge 10d.

In the example of FIGS. 7 and 8, the two belts 4a, 4b, 4 can each be designed as a tensioning belt 5 and also act as such and, in particular, exert a prestressing force on the end plates 3a, 3b in the event of the membrane stack 1 bulging out due to operation. Then, by means of the tensioning belt 5, a prestressing force acting as a counterforce is exerted on the two end plates 3a, 3b, which prevents further expansion of the membrane stack 1 along the stacking direction S.

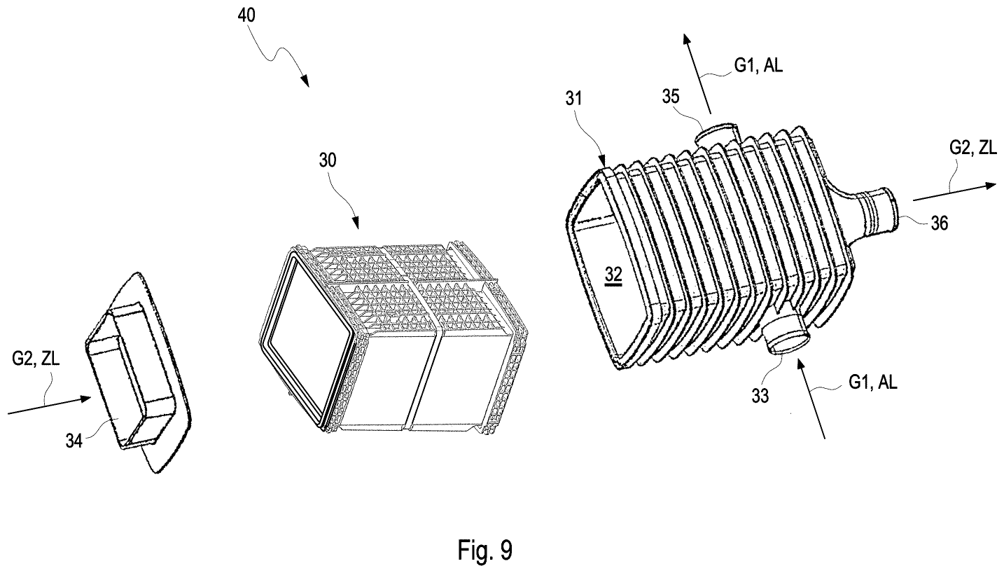

FIG. 9 shows an example of a humidifier according to the invention with a membrane stack assembly according to the invention in an exploded view. The humidifier 30 therefore comprises two gas inlets 33, 34 arranged at a distance from each other on the housing for introducing the humid gas G1 and the gas to be humidified G2 into the housing interior 32. Furthermore, the humidifier 30 comprises two gas outlets 35, 36, formed at a distance from each other on the housing, for discharging the moist gas G1 and the gas to be humidified G2 from the housing interior 32. When the humidifier 30 is in operation, a first gas G1 formed by humid exhaust air AL flows via a first gas inlet 33 into the housing interior 32 and over the first gas paths 22a formed in the membrane stack 20 to the first gas outlet 35. The second gas G2 formed by dry supply air ZL flows into the housing interior 32 via the second gas inlet 34 and to the second gas outlet 36 via the second gas paths 22b formed in the membrane stack 20. Since the membranes 4 are airtight, the dry supply air ZL and the moist exhaust air AL pass through the membrane stack 2 without mixing. Since the membranes 1 are permeable to water vapor, the dry supply air ZL can be humidified by the moist exhaust air AL.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

1. A membrane stack assembly for a humidifier in a fuel cell system, comprising:
a membrane stack including a plurality of gas-tight and moisture-permeable membranes arranged in a stacked configuration along a stacking direction, each of the membranes spaced apart from adjacent membranes to define a plurality of first fluid paths for a first fluid and a plurality of second fluid paths for a second fluid, wherein the first and second fluid paths are fluidly separated from one another by the membranes;
a first end plate and a second end plate facing each other along the stacking direction, wherein the membrane stack is disposed between the first and second end plates; and
at least one belt including a first belt section in contact with an outer side of the first end plate, the outer side facing away from the membrane stack, and a second belt section in contact with an outer side of the second end plate facing away from the membrane stack.

2. The membrane stack assembly according to claim 1, wherein the at least one belt is a tensioning belt configured to exert a prestressing force on at least the first and second end plates.

3. The membrane stack assembly according to claim 1, wherein the at least one belt is closed that completely encircles the first and second end plates and the membrane stack.

4. The membrane stack assembly according to one of claim 1, wherein:
the membrane stack and the first and second end plates together define a shape of cuboid having six outer sides, wherein a first outer side of the cuboid is defined by the first end plate and a second outer side of the cuboid is defined by the second end plate; and
the at least one belt includes a third belt section connecting the first belt section to the second belt section, the third belt section extending along a third outer side of the cuboid, that is different from the first and second outer sides and connects the first and second outer sides or extending along an edge between two outer sides of the cuboid that are different from the first and second outer sides.

5. The membrane stack according to claim 4, wherein:
the at least one belt includes the third belt section connecting the first belt section to the second belt section, the third belt section extending over a third outer side of the cuboid, the third outer side defined by the membrane stack, and connecting the first outer side to the second outer side; and
the at least one belt further includes a fourth belt section connecting the first belt section to the second belt section, the fourth belt extending over a fourth outer side of the cuboid, the fourth outer side defined by the membrane stack and positioned opposite the third outer side, and connecting the first outer side to the second outer side.

6. The membrane stack assembly according to claim 4, wherein:
the first and second outer sides of the cuboid each have a shape of a rectangle; and
the first and second belt sections each extend along a center longitudinal axis of the respective rectangle.

7. The membrane stack assembly according to claim 4, wherein the at least one belt includes two belts, the two belts extend orthogonally to one another around the cuboid.

8. The membrane stack assembly according to claim 4, wherein:
the cuboid includes a third outer side, fourth outer side, fifth outer side, and sixth outer side, connecting the first outer side to the second outer side of the cuboid;
the third belt section of the at least one belt, connecting the first belt section to the second belt section, extends along a first edge disposed between the third outer side and the fifth outer side and rests against the first edge; and
a fourth belt section of the at least one belt, connecting the first belt section to the second belt section, extends along a second edge disposed between the fourth outer side and the sixth outer side and rests against the second edge.

9. The membrane stack assembly according to claim 4, wherein:
each of the first outer side of the cuboid and second outer side of the cuboid has a shape of a rectangle; and
each of the first belt section and second belt section extends along one of two diagonals of the respective rectangle.

10. The membrane stack assembly according to claim 1, wherein the at least one belt includes at least two layers.

11. The membrane stack assembly according to claim 10, wherein the at least two layers are joined to one another along their entire longitudinal extent by a materially integral welded connection.

12. The membrane stack assembly according claim 10, wherein the at least two layers are joined to one another in sections by a materially integral welded connection.

13. The membrane stack assembly according to claim 12, wherein the welded connection is provided exclusively in the first and second belt sections of the belt.

14. The membrane stack assembly according to claim 1, wherein a guide is provided on the first end plate and/or second end plate, the guide configured to receive the first and second belt sections of the belt.

15. The membrane stack assembly according to claim 1, wherein in at least one transition of the first end plate and/or second end plate to the membrane stack a radius is provided in the end plate on which the belt rests.

16. The membrane stack according to claim 1, wherein the at least one belt extends in a longitudinal direction and comprises a belt material which includes fibers extending in the longitudinal direction, which are embedded in a plastic matrix.

17. The membrane stack assembly according to claim 1, wherein a longitudinal tensile strength of the at least one belt measured in the longitudinal direction is at least five times greater than a transverse tensile strength measured perpendicular to the longitudinal direction.

18. The membrane stack assembly according to claim 16, wherein at least 70% by weight of the belt material is the fibers or glass fibers.

19. A humidifier for a fuel cell system and for humidifying a first gas with moisture from a second gas, comprising:
a housing defining a housing interior;
a membrane stack assembly of claim 1 arranged in the housing interior;
a first gas inlet and second gas inlet spaced apart on the housing configured to introduce the humid gas and the gas to be humidified into the housing interior; and
a third gas outlet and a fourth gas outlet spaced apart on the housing and configured to discharge the humid gas and the gas to be humidified from the housing interior.

20. The humidifier according to claim 19, wherein the at least one belt is a tensioning belt configured to exert a prestressing force on at least the first and second end plates.
